(19) United States
(12) Patent Application Publication
(10) Pub. No.: US 2012/0268757 A1
(43) Pub. Date: Oct. 25, 2012

(54) IMAGE FORMING APPARATUS AND IMAGE FORMING METHOD

(76) Inventor: Mikimasa HONMA, Tokyo (JP)

(21) Appl. No.: 13/450,933

(22) Filed: Apr. 19, 2012

(30) Foreign Application Priority Data
Apr. 19, 2011 (JP) 2011-092898

(51) Int. Cl. H04N 1/60

(52) U.S. Cl. 358/1.9

(57) ABSTRACT

An image forming apparatus includes a storage device having a plurality of storage sections to store divided data for image formation, an image forming section to form an image based on the data stored in the storage device and a control section to control the storage device. The control section compares the number A of storage sections usable for storage in the storage device with the number B of storage sections being used for storage of the data, and, when A>B, reads out the data from the B units of storage sections, divides the read-out data and stores the divided data in parallel in the A units of storage sections, whereby a system performance is not lowered even when the number of storage sections changes.

### BACKGROUND OF THE INVENTION

1. Field of the Invention

The present invention relates to an image forming apparatus and an image forming method in each of which data for image formation are stored.

2. Description of Related Art

There exist image forming apparatuses collectively called MFP (Multifunction Peripheral) in which multiple functions acting as a scanner, a printer, a copier, a facsimile, and the like are incorporated in one apparatus. Such image forming apparatuses are required for each job to store various kinds of data, such as scan data acquired by scanning, print data transmitted from external devices before Raster Image Processor (hereafter, described merely as RIP) processing, and image data rasterized in the form of bit map data by the RIP processing.

Accordingly, each of the image forming apparatuses has been equipped with a hard disk drive (hereafter, described merely as HDD) as a nonvolatile storage device for storing a large amount of image data.

Further, in some of the image forming apparatuses, a plurality of HDDs is installed as the storage device. Then, in the case where the plurality of HDDs is used as the storage device, a technique called “striping” or “mirroring” may be employed as described below.

In the technique called “striping”, a set of data is divided for each predetermined size, and the sub-sets of divided data are stored separately in parallel in the plurality of HDDs. Subsequently, the sub-sets of divided data are read out in parallel from the plurality of HDDs, and are output as a set of data. With this, an access speed in the storage device is made to high speed. The striping may be called the level “RAID_{—}0” in Standard RAID levels.

Meanwhile, in the technique called “mirroring”, the same set of data is stored in the plurality of HDDs, whereby the reliability can be increased. The mirroring may be called the level “RAID_{—}1”.

In addition, in order to use such a plurality of HDDs as a storage device in an image forming apparatus, some techniques are proposed in Japanese Unexamined Patent Publication Nos. 2009-230608 and 2010-198424.

In the image forming apparatus disclosed by the above patent publications, each of the plurality of HDDs includes a RAID_{—}0 region and a RAID_{—}1 region, and the RAD_{—}0 region and the RAD_{—}1 region are switched from one to another in accordance with the kind of data to be stored.

FIG. 13 shows a situation in which a plurality of HDDs is installed as a storage device 110 which is configured to store various kinds of data to be handled in an image forming apparatus in HDDs acting as nonvolatile storage sections.

In this situation, HDDs 110A, 110B and 110C are connected to a data line. On the other hand, although a HDD 110D is connectable to the data line, the HDD 110D is not connected or in a non-usable state. Here, a set of data used in the Xth Job are denoted by Datax. That is, a set of data used in the first Job are denoted by Data1.

As shown in FIG. 13, by the control of a control section not shown in the drawings, Data1 are divided for each predetermined size into Data1_1 to Data1_3, Data1_4 to Data1_6, Data1_7 to Data1_9, and Data1_10 to Data1_12, and the divided data are stored separately in parallel in the HDDs 110A, 110B and 110C.

Thus, in the striping, Data1 are divided into three groups, and the three groups are stored in parallel in the three units of HDDs 110A, 110B and 110C. Accordingly, as compared with the case of storage in one unit of HDD, the storage of Data1 can be made about three times faster.

In a storage device equipped with such a plurality of HDDs, each of the plurality of HDDs is configured to be attached detachably. Accordingly, there may be a case where the number of usable (connectable) HDDs is different between at the time of storage of data at a certain time point and at the time of next storage of image data. Further, as another case, at a certain time point, data were stored in HDDs except an inoperative HDD. Thereafter, at the next time, the inoperative HDD returned as a normal HDD, and then, image data are stored in the HDDs and the returned HDD. In the above another case, the number of usable (normal) HDDs is also different between at the certain time point and at the next time.

FIG. 14 shows a situation in which after Data1 were stored in the three units of HDDs shown in FIG. 13, a total of four units of HDDs 110A, 110B, 110C and 110D becomes usable by being connected to the data line.

In this case, by the control of a control section not shown in the drawings, Data2 are divided for each predetermined size into Data2_1 to Data2_4, and the divided data were stored in parallel into the four units of HDDs. With this division, as compared with the case of storage in one unit of HDD, the storage of Data2 can be made about four times faster.

Here, in the HDD 110D shown in FIG. 14, the portion which is indicated by hatching and corresponds to the regions storing Data1 in the HDDs 110A, 110B and 110C, becomes an unused region. The unused region in the HDD 110D is not limited specifically to the position shown in FIG. 14, but may be located at a certain position.

In the case of read-out of Data2, as compared with the case of a single HDD, the read-out can be made four times faster. However, in the case of read-out of Data1, as compared with the case of a single HDD, the read-out is made three times faster. Namely, the read-out of Data1 is reduced to three-quarters (¾) of the available maximum performance of the storage device 110 including the four units of HDDs.

In particular, in the case of an image forming apparatus, both the performance of an image forming section and the read-out speed of a storage device are required to be high speed. The output timing of data from the storage device is absolutely required to be in time for the timing of image formation by the image forming section.

Here, although the image forming section has a performance capable of outputting at high speed and the storage device 110 has the four units of normal HDDs, in the case of read-out of Data1 in FIG. 14, only a read-out speed corresponding to 75% of the maximum performance is available.

For this reason, if the read-out from the storage device becomes late for the timing of image formation by the image forming section, it becomes necessary to reduce the number of output sheets (working speed of the image forming apparatus) per a unit time to 75% or less, such that the number of output sheets is made to coincide with the reduction of the performance of the storage device and the image forming apparatus is enabled to continue operations.

Namely, when data are stored via the striping in HDDs fewer than the number of usable HDDs, two problems arise in such ways that waste is caused in the memory capacity of the storage device 110 as indicated by hatching in FIG. 14, and the reduction of output performance is caused in the image forming apparatus.

### SUMMARY OF THE INVENTION

The present invention has been achieved in view of the above problems, and an object of the present invention is to attain an image forming apparatus and an image forming method each of which can suppress influences of performance deterioration even if the number of storage sections in a storage device is changed. Further, the present invention has been achieved in view of the above problems, and an object of the present invention is to attain an image forming apparatus and an image forming method each of which is configured not to waste a memory capacity even if the number of storage sections in a storage device is changed.

In order to attain at least one of the above-mentioned objects, an image forming apparatus, into which one aspect of the present invention is reflected, comprising:
a storage device having a plurality of storage sections in which divided data for image formation are stored separately;
an image forming section configured to form an image based on the data stored in the storage device; and
a control section configured to control the storage device so as to store the divided data in a plurality of storage sections separately;

wherein the control section controls the storage device by comparing a number A of storage sections usable for storage of data in the storage device with a number B of storage sections being used for storage of the data in the storage device, and, when the number A is larger than the number B (A>B), reading out the data from the B units of storage sections, dividing the read-out data and storing the divided data separately in parallel in the A units of storage sections,

wherein each of A and B representing numeral and one storage section being counted as one unit.

In order to attain at least one of the above-mentioned objects, an image forming method, in which one aspect of the present invention is reflected,
in an image forming apparatus that includes a storage device having a plurality of storage sections in which divided data for image formation are stored separately, an image forming section configured to form an image based on the data stored in the storage device and a control section configured to control the storage device so as to store the divided data in a plurality of storage sections separately, comprising the steps of:

comparing a number A of storage sections usable for storage of data in the storage device with a number B of storage sections being used for storage of the data in the storage device; and

when the number A is larger than the number B (A>B), reading out the data from the B units of storage sections, dividing the read-out data and storing the divided data separately in parallel in the A units of storage sections,

wherein each of A and B representing numeral and one storage section being counted as one unit.

In the image forming apparatus and the image forming method, it is desirable that the storage device supplies the data read-out in parallel from the A units of storage sections which stores the divided data separately to the image forming section, and the image forming section receives the data supplied from the storage device and forms an image.

In the image forming apparatus and the image forming method, it is desirable that the control section divides the read-out data and stores the divided data separately in parallel in the A units of storage sections by striping.

In the image forming apparatus and the image forming method, it is desirable that the control section reads out the data from the B units of storage sections, combines the read-out data, divides the combined data and stores the divided data separately in parallel in the A units of storage sections.

In the image forming apparatus and the image forming method, it is desirable that during a period in which the image forming section does not perform image formation, the control section reads out the data from the B units of storage sections, divides the read-out data and stores the divided data separately in parallel in the A units of storage sections.

In the image forming apparatus and the image forming method, it is desirable that when the image forming section forms an image, the control section reads out the data from the B units of storage sections, supplies the read-out data to the image forming section, divides the read-out data and stores the divided data separately in parallel in the A units of storage sections.

In the image forming apparatus and the image forming method, it is desirable that when a process to read out data from the B units of storage sections, to divide the read-out data and store the divided data separately in parallel in the A units of storage sections is executed for multiple groups of data, sequential order of execution of the process or execution or non-execution of the process is determined for each of the multiple groups based on information associated with each of the multiple groups of data.

In the image forming apparatus and the image forming method, it is desirable that the information is one of a size of the data, a kind of additional processing for the data and execution or non-execution of additional processing (page number, stamp, or decryption) for the image data.

In the image forming apparatus and the image forming method, it is desirable that the process is executed for the multiple groups of data in a descending order of time necessary for the image formation or the additional processing based on the information associated with each of the multiple groups of data.

### BRIEF DESCRIPTION OF THE DRAWINGS

FIG. 1 is a block diagram showing a structure of an image forming apparatus according to an embodiment of the present invention.

FIG. 2 is a flowchart showing operations of the image forming apparatus according to the embodiment of the present invention.

FIG. 3 is an explanatory drawing showing an operating state of the image forming apparatus according to the embodiment of the present invention.

FIG. 4 is an explanatory drawing showing an operating state of the image forming apparatus according to the embodiment of the present invention.

FIG. 5 is an explanatory drawing showing an operating state of the image forming apparatus according to the embodiment of the present invention.

FIG. 6 is an explanatory drawing showing an operating state of the image forming apparatus according to the embodiment of the present invention.

FIG. 7 is an explanatory drawing showing an operating state of the image forming apparatus according to the embodiment of the present invention.

FIG. 8 is a flowchart showing operations of the image forming apparatus according to the embodiment of the present invention.

FIG. 9 is an explanatory drawing showing an operating state of the image forming apparatus according to the embodiment of the present invention.

FIG. 10 is an explanatory drawing showing an operating state of the image forming apparatus according to the embodiment of the present invention.

FIG. 11 is a flowchart showing operations of the image forming apparatus according to the embodiment of the present invention.

FIG. 12 is a flowchart showing operations of the image forming apparatus according to the embodiment of the present invention.

FIG. 13 is a structural diagram showing a state of a conventional memory device.

FIG. 14 is a structural diagram showing a state of a conventional memory device.

### DETAILED DESCRIPTION OF THE INVENTION

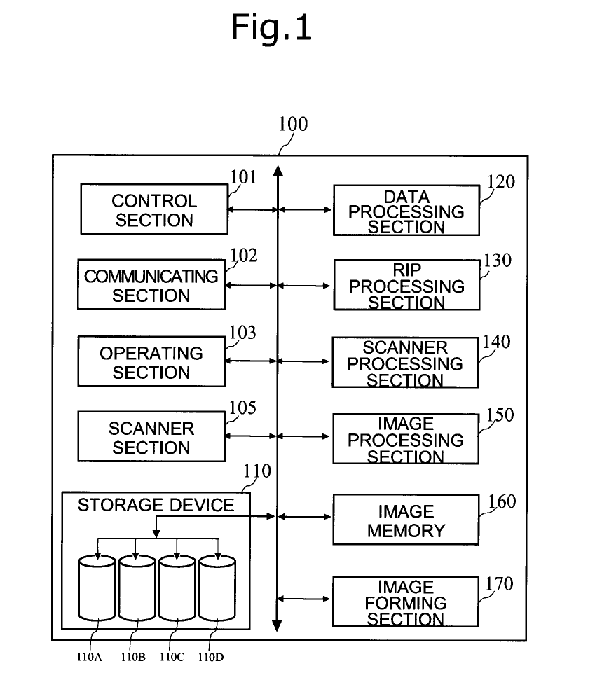

Hereafter, an embodiment for implementing the invention will be described in detail with reference to the drawings. In this description, a specific example will be described based on an image forming apparatus 100 which can act as a copier, a scanner, and a printer, and the like, and includes a storage device for storing data. Hereafter, a structure of the image forming apparatus 100 will be described. The image forming apparatus 100 shown in FIG. 1 includes a control section 101, a communicating section 102, an operating section 103, a scanner section 105, a storage device 110, a data processing section 120, a RIP processing section 130, a scanner processing section 140, an image processing section 150, an image memory 160, and an image forming section 170.

In the above structure, the control section 101 includes a CPU (Central Processing Unit) and the like, and is configured to control each section in the image forming apparatus 100. The communicating section 102 is used at the time of communication with other apparatus via various networks. The operating section 103 includes a liquid crystal display and a touch panel with which a user can input operations. The scanner section 105 is configured to read documents optically with the aid of a light source and a scanning element. The storage device 110 is configured to store various kinds of data to be handled in the image forming apparatus 100 in a hard disk drive (HDD; Hard Disk Drive) serving as a nonvolatile storage unit. The data processing section 120 is configured to perform processing to make the storage device 110 to store print data which are received from an external device not shown in the drawings and are in a situation before being subjected to RIP processing. The RIP processing section 130 is configured to rasterize print data, which are described with a page-description language in a situation before being subjected to the RIP processing, by the RIP (Raster Image Processor) processing, thereby converting the print data into image data in a bitmap format. The scanner processing section 140 is configured to apply various types of processing to data read by the scanner section 105, thereby producing scan data. The image processing section 150 is configured to apply compression processing to image data and scan data to be stored in the storage device 110, and to apply extension processing to image data and scan data which are read out from the storage device 110 in which the image data and the scan data are stored after the compression processing. The image memory 160 is configured to memorize image data temporarily at the time of formation and output of an image. The image forming section 170 is a print engine which is configured to execute formation and output of an image with an electro-photographic system and the like.

The control section 101 is characterized to perform control in the following ways. The control section 101 controls to compare the number A of storage sections usable for storage of data in the storage device 110 with the number B of storage sections being used for the storage of the data being stored in the storage device 110. As a result of comparison, when the number A is larger than the number B (A>B), the control section 101 further controls to read out the data being stored in the B units of storage sections, to combine the read-out data, to divide the combined data, and to store the divided data separately in parallel in the A units of storage sections. In this embodiment, such a process of reading out the data stored in the B units of storage sections, combining the read-out image data, dividing the combined image data, and storing the divided image data separately in parallel in the A units of storage sections, is called “re-division.”

The storage device 110 in this embodiment is constituted by HDDs such as four units of storage sections of a HDD 110A, a HDD 110B, a HDD 110C, and a HDD 110D. In this regard, a plurality of storage sections recited in claims means a plurality of HDDs. The storage device 110 may include at least two HDDs as the plurality of storage sections, and is not limited in terms of the upper limit. In the storage device 110, image data are divided and stored separately in parallel in the plurality of HDDs (HDD 110A to HDD 110D) by striping of the level RAID_{—}0 based on the control of the control section 101, whereby storage and read-out can be executed at high speed.

Hereafter, input operations in the storage device 110, i.e., processing for storage will be described. First, description will be given simply for operations performed in this embodiment at the time when image data are divided and stored separately in parallel in a plurality of storage sections in the storage device 110. In this description, operations for image data after the RIP processing are made as a specific example.

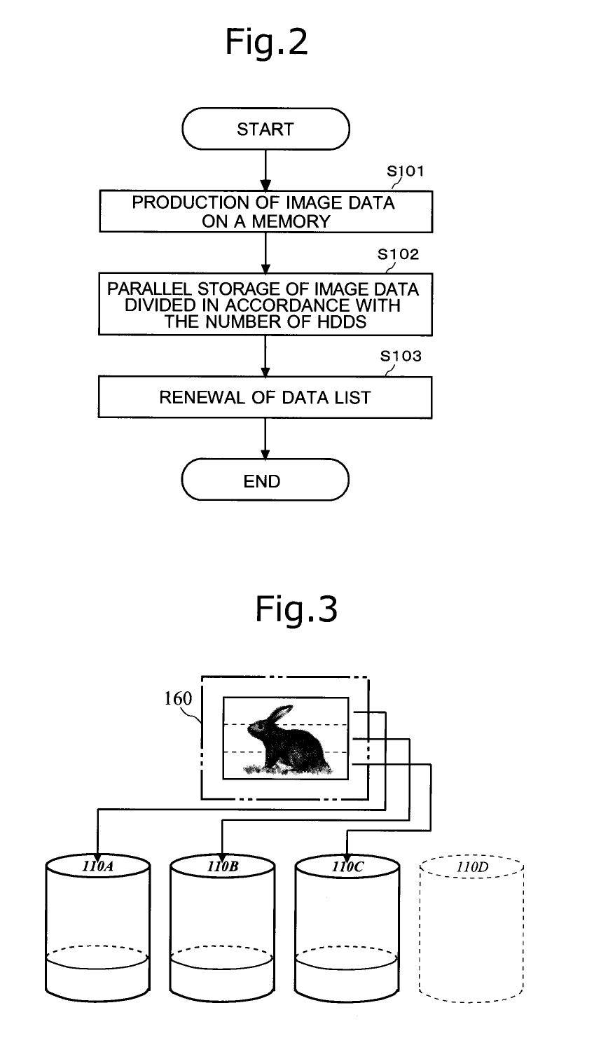

The image data which have been rasterized by the RIP processing in the RIP processing section 130 are temporarily developed in the image memory 160 for each page (Step S101 in FIG. 2).

Then, by the control of the control section 101 based on the striping, the image data developed in the image memory 160 are divided in accordance with the number of HDDs usable in the storage device 110, and the divided image data are stored separately in parallel in the respective HDDs (Step S102 in FIG. 2).

For example, as shown in FIG. 3, it is assumed that the HDDs 110A, 110B, and 110C are connected to become usable, and the HDD 110D is unconnected or in an unusable state. In this case, with the control of the control section 101, image data are divided and stored separately in parallel in the HDDs 110A to 110C.

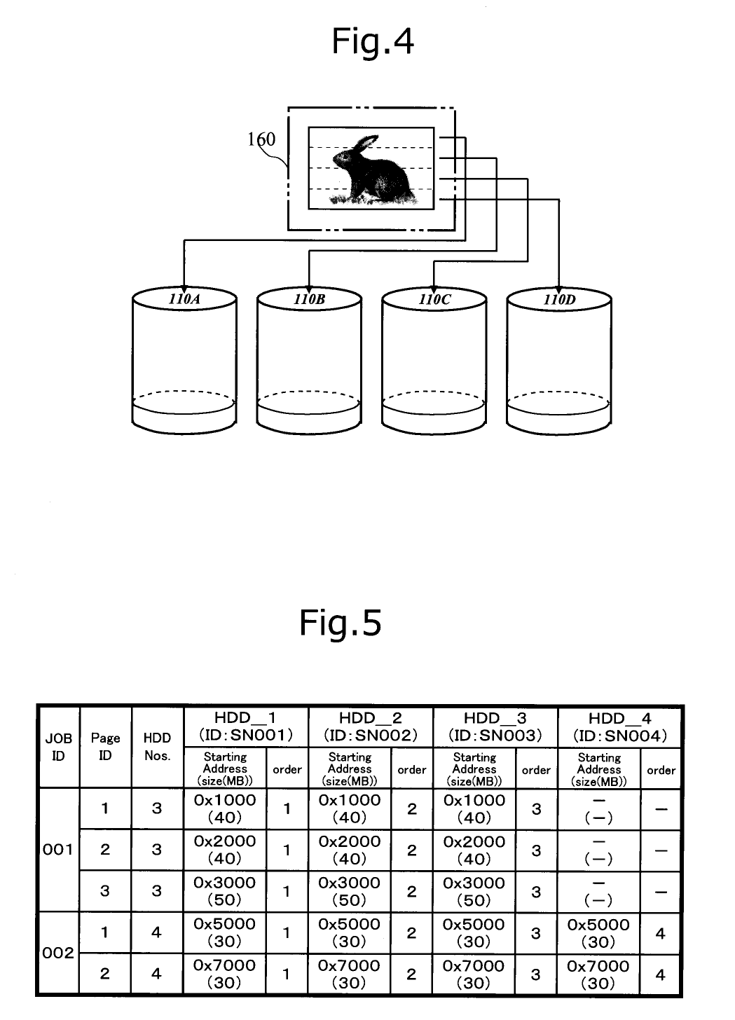

Further, as shown in FIG. 4, in the case where the HDDs 110A, 110B, 110C and 110D are connected to become usable, with the control of the control section 101, image data are divided and stored separately in parallel in the HDDs 110A to 110D.

After the image data are divided and stored separately in parallel in the respective HDDs, the control section 101 controls to renew data lists of JOB ID, Page ID, the number of HDDs being used for storage, the ID of each of the HDDs, the start address and memory capacity of each of the HDDs, and the sequential order at the time of storage in parallel in each of the HDDs. Successively, the control section 101 controls so as to store the renewed data list at a proper position in the storage device 110 (Step S103 in FIG. 2).

In FIG. 3 and FIG. 4, the whole image data are schematically illustrated to be divided into three or four groups. However, actually, the image data are controlled to be divided for each predetermined size, and then the divided image data are stored separately in parallel in three or four HDDs.

Here, in a data list shown in FIG. 5, the respective ID codes of the four units of the HDDs 110A to 110D are registered as HDD_{—}1 (ID: SN001) to HDD_{—}4 (ID: SN004).

In this data list, in page 1 of Job ID: 001, the number of HDDs is 3. In HDD_{—}1, the starting address is “0x1000”, the size is 40 MB (Mega Byte), and the sequential order is 1.

In HDD_{—}2, the starting address is “0x1000”, the size is 40 MB, and the sequential order is 2. In HDD_{—}3, the starting address is “0x1000”, the size is 40 MB, and the sequential order is 3.

In page 2 of Job ID: 001, the number of HDDs is 3. In HDD_{—}1, the starting address is “0x2000”, the size is 40 MB, and the sequential order is 1. In HDD_{—}2, the starting address is “0x2000”, the size is 40 MB, and the sequential order is 2. In HDD_{—}3, the starting address is “0x2000”, the size is 40 MB, and the sequential order is 3.

In page 3 of Job ID: 001, the number of HDDs is 3. In HDD_{—}1, the starting address is “0x3000”, the size is 50 MB, and the sequential order is 1. In HDD_{—}2, the starting address is “0x3000”, the size is 50 MB, and the sequential order is 2. In HDD_{—}3, the starting address is “0x3000”, the size is 50 MB, and the sequential order is 3.

Further, in this data list, in page 1 of Job ID: 002, the number of HDDs is 4. In HDD_{—}1, the starting address is “0x5000”, the size is 30 MB, and the sequential order is 1.

In HDD_{—}2, the starting address is “0x5000”, the size is 30 MB, and the sequential order is 2. In HDD_{—}3, the starting address is “0x5000”, the size is 30 MB, and the sequential order is 3. In HDD_{—}4, the starting address is “0x5000”, the size is 30 MB, and the sequential order is 4.

In page 2 of Job ID: 002, the number of HDDs is 4. In HDD_{—}1, the starting address is “0x7000”, the size is 30 MB, and the sequential order is 1. In HDD_{—}2, the starting address is “0x7000”, the size is 30 MB, and the sequential order is 2. In HDD_{—}3, the starting address is “0x7000”, the size is 30 MB, and the sequential order is 3. In HDD_{—}4, the starting address is “0x7000”, the size is 30 MB, and the sequential order is 4.

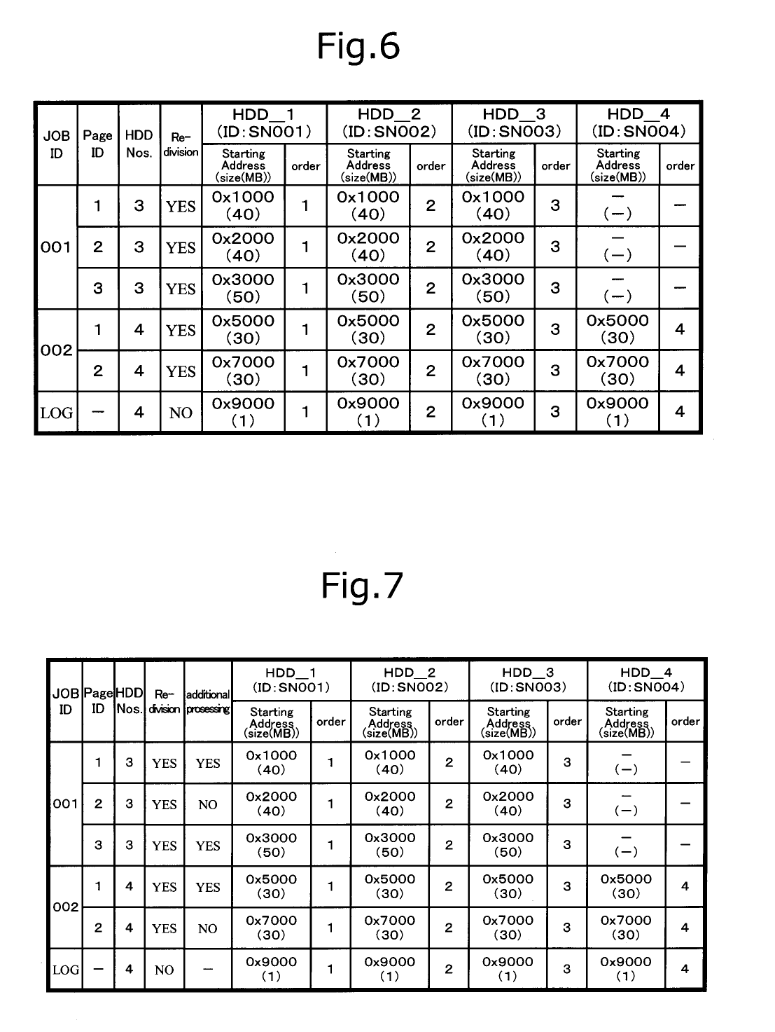

In addition to the data list shown in FIG. 5, in a case shown in FIG. 6, log data (Job ID is represented with “LOG” in FIG. 6) which indicate machinery states, are stored in the storage device 110. These log data indicate various situations, such as machinery states, operation situations, and error codes at the time of occurrence of trouble. These log data are referenced at the time of maintenance, and the data size of the log data is small. For this reason, the re-division of data is not needed for the log data. Hence, in order to specify YES (existence, execution) or NO (non-existence, non-execution) of the necessity of re-division, an item “Re-division” is provided as shown in the data list of FIG. 6. Accordingly, the item of “Re-division” may be set to YES for image data, and may be set to NO for log data. Subsequently, at the time of execution of re-division, the control section 101 may switch between YES and NO for the execution of re-division by referring to this item.

Further, in addition to the data lists shown in FIG. 5 or FIG. 6, as shown in the data list of FIG. 7, it is also possible to provide an item “Additional Processing” with regard to YES (existence) or NO (non-existence) of the necessity of additional processing for image data. For example, there may be a case where it is necessary to execute various types of additional processing, such as processing for decrypting codes, processing for adding page numbers, and processing for adding stamps. In the above case, since such additional processing takes time for processing, spare time for image formation decreases.

Accordingly, it is desirable to execute re-division processing according to this embodiment more preferentially than other processing. As a result, the processing time can be saved so as to provide spare time as much as possible and to prevent lowering of image forming and outputting performances. Hence, in order to specify YES or NO of the necessity of additional processing for each of image data, an item “Additional Processing” is provided. Accordingly, the control section 101 is configured to refer to the item of “Additional Processing”. Then, when “Additional Processing” is set to YES for image data, the control section 101 is configured to control to execute the re-division processing for the image data more preferentially. Further, not only the item of YES or NO of additional processing, but also an item “Content” of additional processing” may be provided in the data list. At the time of processing of image data, based on the length of processing time estimated from the content of additional processing, the control section 101 may execute the re-division processing more preferentially for the image data which take longer processing time for the additional processing. In this regard, it is desirable that the processing time estimated from the content of additional processing is described in a table which is not shown in the drawings.

Hereafter, the re-division processing as the characterized portion in this embodiment will be described. When the image forming section 170 has not performed image formation for a predetermined time or more, the control section 101 judges such a time period as an idle period, and is configured to execute the re-division processing described below.

In the image forming apparatus 100, since image data are stored in the storage device 110 before being used for image formation, it is effective to execute the re-division processing for the image data during the idle period.

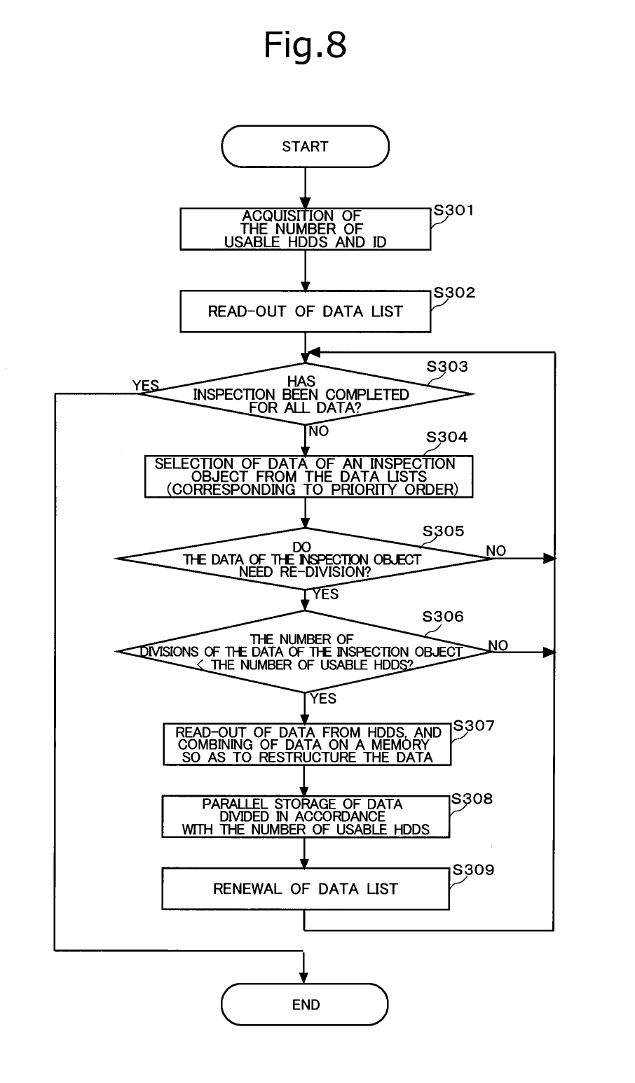

First, the control section 101 collects the information in the image forming apparatus 100, and acquires the number of HDDs usable at the present time and the respective ID codes of the HDDs (Step S301 in FIG. 8). The usable HDD refers to a HDD which is connected the data line in the storage device 110 and is in the state that it can perform storage and read-out of image data.

Further, the control section 101 reads out data lists similar to those shown in FIGS. 5 to 7 from the storage device 110 (Step S302 in FIG. 8).

Then, the control section 101 checks whether the following inspection has been completed for all image data listed in the data list (Step S303 in FIG. 8). In the case where the inspection has been completed (Yes at Step S303 in FIG. 8), the control section 101 ends the processing in this step (End in FIG. 8). Alternatively, in the case where the inspection has not been completed (No at Step S303 in FIG. 8), the control section 101 performs the processing mentioned below.

The control section 101 selects image data, for which the inspection has not been completed, as an inspection object from the data lists (Step S304 in FIG. 8). At this time, in the case where a priority order is determined beforehand, the control section 101 selects image data sequentially in a descending order from a higher order in the priority order in accordance with the criteria for the priority order. In this case, the priority order may be made to a descending order of data size, a descending order of processing time for additional processing, and the like in accordance with the necessity of the re-division. Here, the control section 101 can acquire information about data size and YES or NO of additional processing from the data lists.

In the case of the data list shown in FIG. 6, since the region at “page ID: 3” of “Job ID: 001” indicates the largest data size, the image data stored in this region are processed with the top priority. In the case of the data list shown in FIG. 7, the region at “page ID: 3” of “Job ID: 001” indicates the largest data size and “YES” in the item of “Additional Processing”, the data stored in this region are processed with the top priority.

Thus, with the judgment of the priority based on data size and additional processing, the control section 101 can execute the re-division processing preferentially in the order from image data which have higher necessity of re-division and higher effects obtainable from the re-division (i.e., suppression of output performance deterioration in image formation, or elimination of waste in a memory capacity), whereby the control section 101 can advance the re-division processing efficiently. Namely, information in association with image data is prepared so as to include the following items: the size of image data, flag or table of the priority of image data, and type or necessity (YES or NO) of additional processing (page number, stamp, decryption, and the like) for image data. Then, based on at least one of the above items, the control section 101 determines the sequential order of execution or YES or NO of execution of the re-division processing for the image data in the descending order of time taken for image formation or additional processing. Successively, based on the determination, the control section 101 advances the re-division processing efficiently. As a result, elimination of waste in a memory capacity and elimination of performance deterioration in image formation and image output can be attained efficiently.

In the flowchart shown in FIG. 8, the control section 101 judges whether the selected image data need the re-division processing (Step S305 in FIG. 8). With regard to the necessity of the re-division processing, the control section 101 refers to the item of “Re-division” in the data lists in FIG. 6 or FIG. 7. Thus, the judgment of the necessity of the re-division processing enables the control section 101 to advance the re-division processing efficiently only for image data which need the re-division processing.

When the selected image data do not need the re-division processing (NO at Step S305 in FIG. 8), the control section 101 returns to Step S303, and advances the processing for other image data.

When the selected image data need the re-division processing (YES at Step S305 in FIG. 8), the control section 101 compares the number A of HDDs usable for storage of image data in the storage device 110 with the number B of HDDs being used for storage of the image data (Step S306 in FIG. 8).

When the comparison result does not indicate “A>B” (NO at Step S306 in FIG. 8), since the re-division is not needed for the selected image data, the control section 101 returns to Step S303, and advances the processing for other image data.

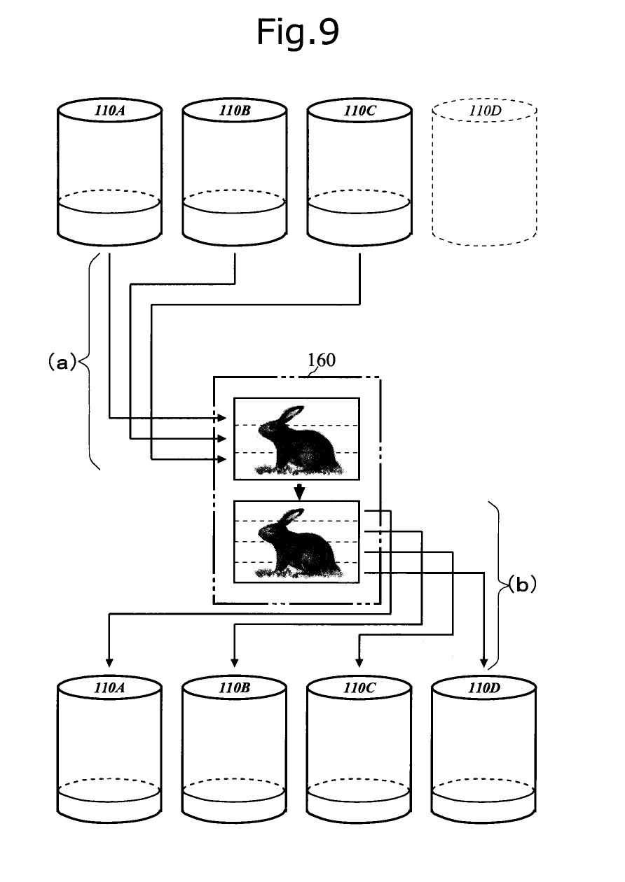

On the other hand, when the comparison result indicates “A>B” (YES at Step S306 in FIG. 8), that is, when image data are stored in the number B of HDDs smaller than the number A of HDDs usable at the present time, since the re-division is needed for the selected image data, the control section 101 reads out image data in parallel from the B units of storage sections (HDDs), combines the read-out image data in the image memory 160 so as to restructure the image data on the original state (Step S307 in FIG. 8). This state is shown at a portion (a) in FIG. 9. The portion (a) in FIG. 9 schematically shows the state in which image data are read out from three units of HDDs and combined in the image memory 160 so as to restructure the image data in the original state.

Successively, for the restructured image data which are read out from the B units of HDDs and combined in the image memory 160, the control section 101 performs the control of striping such that the restructured image data are divided and stored separately in parallel in the A units of usable HDDS (Step S308 in FIG. 8). This state is shown at a portion (b) in FIG. 9. The portion (b) in FIG. 9 schematically shows a state in which the restructured image data by being read out from three units of HDDs and combined in the image memory 160 are stored separately in parallel in four units of HDDs. At this time, since the image data are stored separately in parallel in four units of HDDs, the storage processing can be finished in a short time. Accordingly, since influences exerted to other processing can be reduced, it is desirable.

Further, for the image data which were subjected to the re-division processing from the B units of HDDs to the A units of HDDs in the above ways, the control section 101 revises the changed items in the data lists and renews the data lists (Step S309 in FIG. 8).

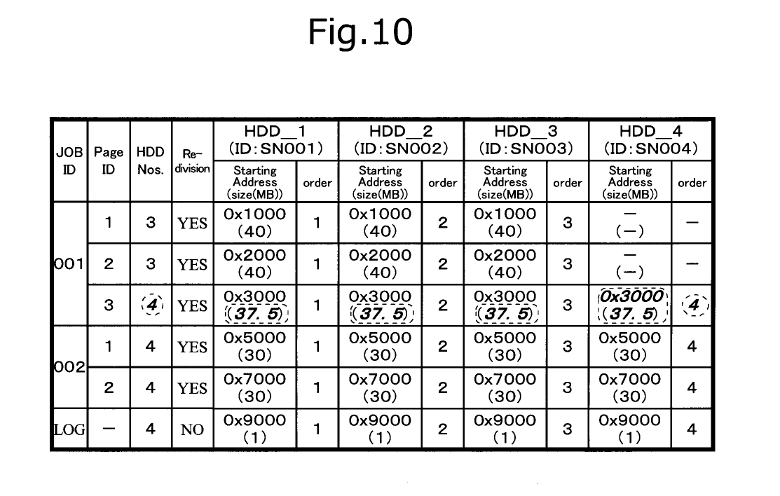

In the case of the data list shown in FIG. 6, in the region at “Page ID: 3” of “Job ID: 001”, when the image data were subjected to the re-division processing from the three units of HDDs to the four units of HDDs, the data list is renewed as shown in FIG. 10. Here, as shown in the changed items enclosed with broken lines in FIG. 10, the number of HDDs is changed from 3 to 4, the data size of each of HDDs is changed from 50 to 37.5, the item of Starting Address (Size) and Sequential Order in HDD_{—}4 is written in similarly to HDD_{—}1 to HDD_{—}3.

Subsequently, upon completion of the re-division processing for the image data in the above ways, the control section 101 returns to Step S303 and continues the same processing as the above for other image data until the inspection for all the image data is completed. Thus, elimination of waste in a memory capacity and elimination of output performance deterioration at the time of image formation can be attained by effective utilization of an idle period without any influence for the operations of image formation.

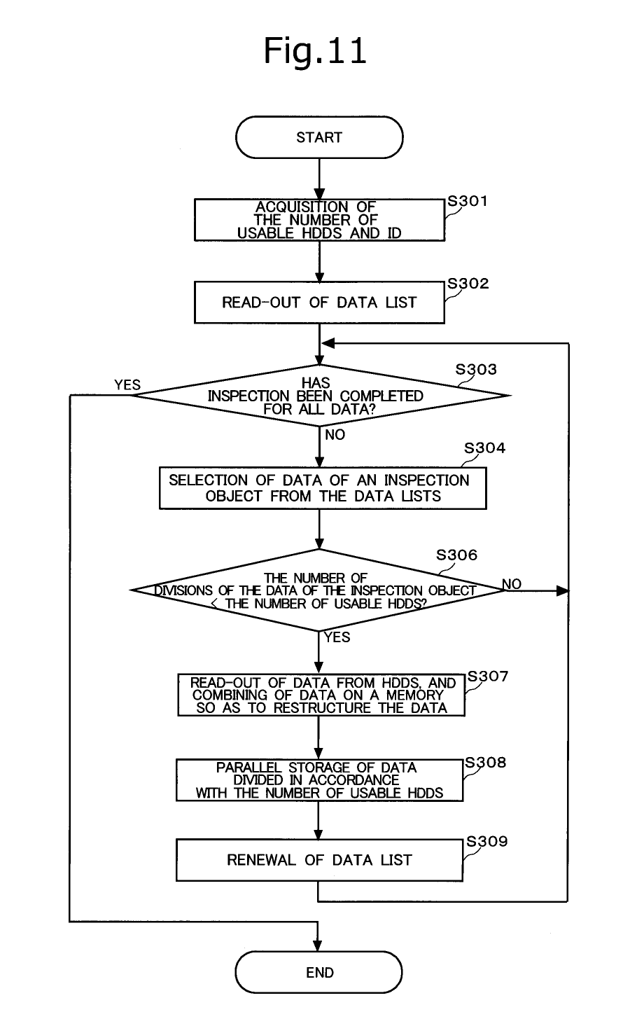

In the above description of the embodiment based on the flowchart shown in FIG. 8, image data are selected as an inspection object in accordance with the priority order, and then, subjected to the re-division processing. However, the judgment with regard to the priority order and the necessity of re-division may be omitted. Hereafter, with reference to a flowchart shown in FIG. 11, description will be given for an embodiment in which image data are selected as an inspection object and subjected to the re-division processing with omission of the judgment for the priority and the necessity of re-division.

In this case, the control section 101 collects the information in the image forming apparatus 100, and acquires the number of HDDs usable at the present time and the respective ID codes of the HDDs (Step S301 in FIG. 11). Further, the control section 101 reads out data lists from the storage device 110 (Step S302 in FIG. 11).

Then, the control section 101 checks whether the following inspection has been completed for all the image data listed in the data list (Step S303 in FIG. 11). When the inspection has been already completed for all the image data (Yes at Step S303 in FIG. 11), the control section 101 ends the processing (End in FIG. 11). Alternatively, when the inspection has not been completed for all the image data (No at Step S303 in FIG. 11), the control section 101 executes the processing mentioned below.

The control section 101 selects image data, for which the inspection has not been completed, as an inspection object from the data lists (Step S304 in FIG. 11). At this time, the control section 101 selects sequentially image data from a higher rank or a lower rank in the data list.

With regard to the selected image data, the control section 101 compares the number A of HDDs usable for storage of image data in the storage device 110 with the number B of HDDs being used for storage of the image data stored in the storage device 110 (Step S306 in FIG. 11).

When the comparison result does not indicate “A>B” (NO at Step S306 in FIG. 11), since the re-division is not needed for the selected image data, the control section 101 returns to Step S303, and advances the processing for other image data.

On the other hand, when the comparison result indicates “A>B” (YES at Step S306 in FIG. 11), that is, when the image data are stored by the number B of HDDs smaller than the number A of HDDs usable at the present time, since the re-division is needed for the selected image data, the control section 101 reads out the image data in parallel from the B units of storage sections (HDDs), combines the read-out image data in the image memory 160 so as to restructure the image data on the original state (Step S307 in FIG. 11).

Then, for the image data restructured by being read out from B units of HDDs and combined in the image memory 160, the control section 101 performs the control of striping such that the restructured image data are divided and stored separately in parallel in A units of usable HDDS (Step S308 in FIG. 11).

Further, for the image data which were subjected to the re-division processing from the B units of HDDs to the A units of HDDs in the above ways, the control section 101 revises the changed items in the data lists and renews the data lists (Step S309 in FIG. 11).

Subsequently, upon completion of the re-division processing for the image data in the above ways, the control section 101 returns to Step S303 and continues the same processing as the above for other image data until inspection for all the image data is completed.

Hereafter, description will be given simply for output operations of the image forming apparatus 100 and operations performed at the time when image data stored by striping in a plurality of HDDs are read out from the storage device 110 and an image is formed in the image forming section 170.

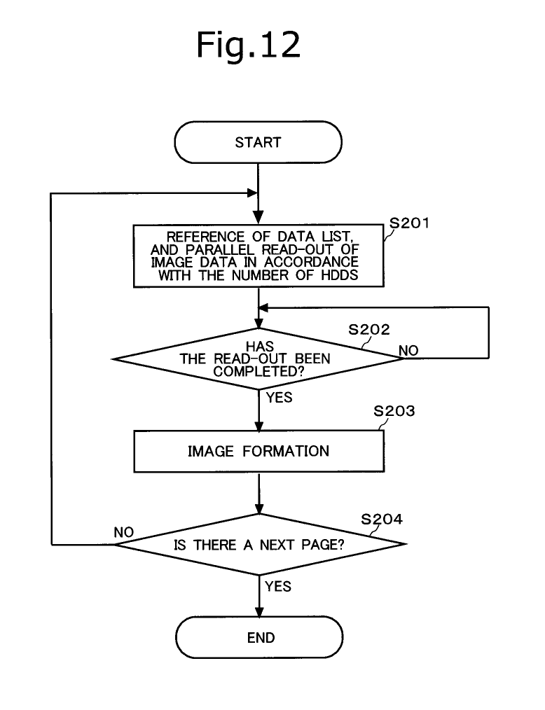

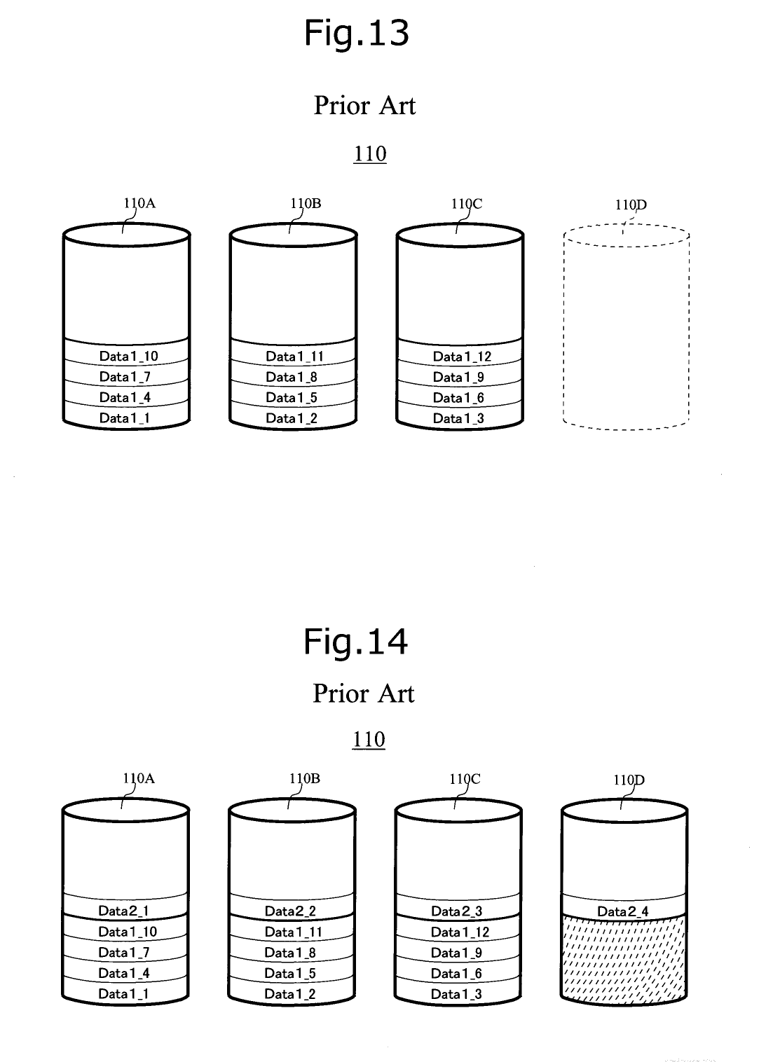

Upon receipt of an instruction of image formation for any one of jobs from a non-illustrated external device or the operating section 103, the control section 101 refers to the data lists, and reads out the image data of the image formation target in parallel from respective HDDs (Step S201 in FIG. 12).

That is, the image data divided and stored separately in parallel in the respective HDDs of the storage device 110 are read out by striping in parallel corresponding to the number of HDDs used for storage of the image data by the control of the control section 101.

Upon completion of read-out in parallel for the image data in this page from the respective HDDs (YES at Step S202 in FIG. 12), the control section 101 performs control such that the read-out image data are combined in the image memory 160, and the combined image data are subjected to image processing in the image processing section 150, and then, supplied to the image forming section 170. Successively, under the control of the control section 101, the image forming section 170 conducts image exposure based on the image data, feeds a recording sheet, and forms an image on the recording sheet (Step S203 in FIG. 12).

In the actual operations, the image forming section 170 repeats the image formation with a predetermined speed. Accordingly, the control section 101 performs control in the following ways. That is, image data are read out in parallel from the respective HDDs of the storage device 110, and combined in the image memory 160, and the combined image data are supplied to the image forming section 170 via the image memory 160 so as to be in time for the image formation timing.

Further, the control section 101 performs control so as to repeat the operation to read out in parallel image data (Step S201 in FIG. 12) and the operation to form images (Step S203 in FIG. 12) as mentioned above until the processing for all the page of image formation jobs is completed.

In the above operations, with the above-mentioned re-division processing, image data stored in parallel in the B units of HDDs smaller than the number A of usable HDDs are divided again and stored separately in parallel in the A units of usable HDDs. Accordingly, it becomes possible to execute the striping on the condition that the performance of the storage device 110 can be exerted without waste. That is, since the waste in a memory capacity corresponding to a difference of A and B units of HDDs is eliminated, output performance deterioration at the time of image formation can be prevented beforehand.

Hereafter, another embodiment (1) will be described.

In the above description, the input operation (storage) described with reference to FIG. 2 is the storage configured to be performed in parallel by the striping, and the output operation (read-out, and image formation) described with reference to FIG. 12 is the read-out configured to be performed in parallel by the striping. In contrast, in the processing operation in the re-division described with reference to FIG. 8 and FIG. 11, since it is permissible to store image data in the respective HDDs with the same data arrangement as that in the storage performed in parallel by the striping, the storage may not be performed actually in parallel. That is, in the case where the re-division processing of this embodiment is performed in parallel to other processing, in accordance with the respective processing abilities of the control section 101 and each section, the divided image data are not necessarily stored in parallel into the HDD 110A to HDD 110D, and the divided image data may be stored sequentially into the HDD 110A to HDD 110D. The operation performed in this way facilitates the simultaneous processing of the re-division processing and other processing.

For example, in a time period in which, although the image forming section 170 stops image formation, other processing such as scanning, transmission and reception in facsimile is being performed, it is desirable to reduce loads in the control section 101 and the storage device 110 by execution of sequential storage in the re-division processing.

Hereafter, another embodiment (2) will be described.

In the above description, the re-division processing is controlled to perform operations such that image data are read out from the B units of HDDs and combined, and the restructured image data are divided and stored separately in parallel in the A units of usable HDDs. However, in the above operations, the operation to restructure by combining may be omitted. That is, the control section 101 may perform control to divide and store image data in parallel in the A units of HDDs while reading out the image data stored in the B units of HDDs without performing the operation to restructure by combining.

Hereafter, another embodiment (3) will be described.

In the above description, with reference to FIG. 8 and FIG. 11, the re-division processing is described to be executed in an idle period during which the image forming section 170 does not perform image formation. However, the timing to execute the re-division processing should not be limited to the idle period.

For example, at a timing when the image forming section 170 performs image formation for certain image data, the re-division processing is executed for the certain image data which are read out for image formation from the respective HDDs in the storage device 110 and combined in the image memory 160. That is, the control section 101 performs control to compare the number A of usable HDDs with the number B of HDDs being used for storage of the certain image data (Step S306), to store the certain image data in the A units of usable HDDs (Step S308), and to renew the data list (Step S309).

In the case of such “in the course of image formation”, image data are combined in the image memory 160 for image formation after being read out in parallel from the respective HDDs of the memory device 110. Accordingly, in order to complete the re-division processing, the control section 101 is required to perform only the judgment (Step S306), the storage in the A units of usable HDDs (Step S308), and the renewal of the data lists (Step S309). Accordingly, even in the course of image formation, it becomes possible to execute the re-division processing. Therefore, even in the case where there exist no idle period, it becomes possible to execute the re-division processing for each time when image data are used for image formation.

Hereafter, another embodiment (4) will be described.

In the above embodiment, as a specific example, description is given for the case where the re-division processing is executed for the image data which have been subjected to the RIP processing. However, the present invention should not be limited to this example. For example, the re-division processing may be executed for print data before the RIP processing. In this case, since the supply of print data from the storage device 110 to the RIP processing section 130 is performed at high speed, waste in a memory capacity may be eliminated.

Further, similarly, the re-division processing may be also executed for various kinds of data, such as scan data produced by the scanner section 105, and facsimile data produced by a facsimile processing section not shown in the drawings. As a result, the supply of the various kinds of data is performed at high speed, whereby the effect to eliminate waste in a memory capacity may be attained.

Hereafter, another embodiment (5) will be described.

In the above embodiment, as a specific example of the HDDs of the storage device 110, the case of three units or four units is exemplified. However, as long as at least two units of HDDs can be connected to data lines of a storage device, the present embodiment can be applied to the storage device, whereby good results can be attained. For examples, in a storage device in which two units of HDDs are usually connected, when image data are stored in one unit of HDDs due to trouble, the image data are divided and stored in the two units of HDDs by the re-division processing. As a result, as mentioned above, read-out of the image data can be performed at high speed, and waste in a memory capacity can be eliminated.

Further, in the above embodiment, the HDDs are employed as a specific example of nonvolatile storage sections. However, the present invention should not be limited to this example. For example, it may be also possible to employ nonvolatile semiconductor storage sections, whereby read-out of data can be performed at high speed, and waste in a memory capacity can be eliminated.

Moreover, the present invention should not be limited to the contents shown in the above-mentioned embodiments. Namely, the present invention may be implemented with application of various modifications within a range of the spirit of the present invention and the description in the above-mentioned embodiments.

What is claimed is:

1. An image forming apparatus comprising:
a storage device having a plurality of storage sections in which divided data for image formation are stored separately;
an image forming section configured to form an image based on the data stored in the storage device; and
a control section configured to control the storage device so as to store the divided data in a plurality of storage sections separately;
wherein the control section controls the storage device by comparing a number A of storage sections usable for storage of data in the storage device with a number B of storage sections being used for storage of the data in the storage device, and, when the number A is larger than the number B (A>B), reading out the data from the B units of storage sections, dividing the read-out data and storing the divided data separately in parallel in the A units of storage sections, wherein each of A and B representing numeral and one storage section being counted as one unit.

2. The image forming apparatus claimed in claim 1, wherein the control section divides the data and stores the divided data separately in parallel in the A units of storage sections by striping.

3. The image forming apparatus claimed in claim 1, wherein the control section reads out the data from the B units of storage sections, combines the read-out data, divides the combined data and stores the divided data separately in parallel in the A units of storage sections.

4. The image forming apparatus claimed in claim 1, wherein when a process to read out data from the B units of storage sections, to divide the read-out data and to store the divided data separately in parallel in the A units of storage sections is executed for multiple groups of data, the control section determines a sequential order of execution of the process or execution or non-execution of the process for each of the multiple groups based on information associated with each of the multiple groups of data.

5. An image forming method, in an image forming apparatus that includes a storage device having a plurality of storage sections in which divided data for image formation are stored separately, an image forming section configured to form an image based on the data stored in the storage device and a control section configured to control the storage device so as to store the divided data in a plurality of storage sections separately, comprising the steps of:
comparing a number A of storage sections usable for storage of data in the storage device with a number B of storage sections being used for storage of the data in the storage device; and
when the number A is larger than the number B (A>B), reading out the data from the B units of storage sections, dividing the read-out data and storing the divided data separately in parallel in the A units of storage sections,
wherein each of A and B representing numeral and one storage section being counted as one unit.

6. The image forming method claimed in claim 5, wherein the storage device supplies the data read-out in parallel from the A units of storage sections which stores the divided data separately to the image forming section, and the image forming section receives the data supplied from the storage device and forms an image.

7. The image forming method claimed in claim 5, wherein the control section divides the read-out data and stores the divided data separately in parallel in the A units of storage sections by striping.

8. The image forming method claimed in claim 5, wherein the control section reads out the data from the B units of storage sections, combines the read-out data, divides the combined data and stores the divided data separately in parallel in the A units of storage sections.

9. The image forming method claimed in claim 5, wherein during a period in which the image forming section does not perform image formation, the control section reads out the data from the B units of storage sections, divides the read-out data and stores the divided data separately in parallel in the A units of storage sections.

10. The image forming method claimed in claim 5, wherein when the image forming section forms an image, the control section reads out the data from the B units of storage sections, supplies the read-out data to the image forming section, divides the read-out data and stores the divided data separately in parallel in the A units of storage sections.

11. The image forming method claimed in claim 5, wherein when a process to read out data from the B units of storage sections, to divide the read-out data and store the divided data separately in parallel in the A units of storage sections is executed for multiple groups of data, sequential order of execution of the process or execution or non-execution of the process is determined for each of the multiple groups based on information associated with each of the multiple groups of data.

12. The image forming method claimed in claim 11, wherein the information is one of a size of the data, a kind of additional processing for the data and execution or non-execution of additional processing for the data.

13. The image forming method claimed in claim 12, wherein the process is executed for the multiple groups of data in a descending order of time necessary for the image formation or the additional processing based on the information associated with each of the multiple groups of data.
